(19) United States
(12) Patent Application Publication
(10) Pub. No.: US 2014/0145083 A1
(43) Pub. Date: May 29, 2014

(54) PLASTIC IDENTIFICATION DEVICE

(71) Applicant: SHIMADZU CORPORATION, Kyoto-shi (JP)

(72) Inventors: Toru Yamaguchi, Kyoto (JP); Naoji Moriya, Kyoto (JP)

(73) Assignee: SHIMADZU CORPORATION, Kyoto-shi (JP)

(21) Appl. No.: 14/072,067

(22) Filed: Nov. 5, 2013

(30) Foreign Application Priority Data
Nov. 28, 2012 (JP) 2012-259243

(51) Int. Cl. G01N 21/35

(52) U.S. Cl. CPC G01N 21/3563
USPC 250/339.08

(57) ABSTRACT

A plastic identification device includes a sample holding unit for holding, as a sample, a plastic to be identified, an infrared spectrophotometer including a light source for generating infrared light, an incident optical system for emitting the infrared light from the light source on the sample held by the sample holding unit, a light detector, and a receiver optical system for guiding the infrared light from the sample to the light detector, and a calculation device for identifying a type of the plastic which is the sample based on a detection result of the light detector. A focal length of the incident optical system is shorter than a focal length of the receiver optical system.

### BACKGROUND OF THE INVENTION

1. Field of the Invention

The present invention relates to a plastic identification device for identifying the type of a plastic to be identified, and relates to, for example, a plastic identification device including a Fourier transform infrared spectrophotometer.

2. Description of the Related Art

For example, in recycling waste plastic in the home appliance industry, the automotive industry and the like, identification of the type of a plastic is performed.

Conventionally, with respect to a method of identifying the type of a plastic in a non-contact manner using light, there is a plastic identification device that extracts a difference in the shape of the reflectance spectrum in a mid-infrared region of a plastic to be identified (for example, see Japanese Patent Laid-open Publication No. 2001-221727). In this plastic identification device, a Fourier transform infrared spectrophotometer (FTIR) is used to acquire the reflectance spectrum.

FIG. 5 is a schematic configuration diagram of a FTIR. A FTIR 100 includes a light source 101, a converging mirror 103, an aperture 105, a collimator mirror 107, a beam splitter 109, a movable mirror 111, a fixed mirror 113, an incident mirror 115, a receiver mirror 117, a converging mirror 119, and a light detector 121.

Light, including the mid-infrared region, emitted from the light source 101 enters the beam splitter 109 via the converging mirror 103, the aperture 105, and the collimator mirror 107, and is split by the beam splitter 109 into two directions to the movable mirror 111 and the fixed mirror 113. Light reflected by the movable mirror 111 and light reflected by the fixed mirror 113 are combined by the beam splitter 109.

The movable mirror 111 is displaced in the direction of the arrow in FIG. 5 by a drive system not shown. A phase difference occurs between the optical path from the movable mirror 111 and the optical path from the fixed mirror 113 due to the displacement of the movable mirror 111. The light is combined by the beam splitter 109.

The combined light in the mid-infrared region from the beam splitter 109 is transmitted to the optical path towards the incident mirror 115. The combined light in the mid-infrared region reflected by the incident mirror 115 is collected on and enters a plastic 123 to be identified arranged at a predetermined measurement position. Light reflected by the plastic 123 to be identified enters the receiver mirror 117. Light reflected by the receiver mirror 117 enters the light detector 121 via the converging mirror 119.

FIG. 6 is a diagram for describing a relationship between the displacement of a movable mirror and interferogram intensity (a.u. (arbitrary unit)) in the FTIR. When the phase difference between the optical path from the movable mirror 111 and the optical path from the fixed mirror 113 is zero, all the wavelengths in the light combined by the beam splitter 109 intensify one another, and thus, the interferogram intensity is maximized. This is called a center burst.

With the plastic identification device, the type of the plastic 123 to be identified is identified by a calculation device, not shown, based on the shape of the reflectance spectrum of the plastic 123 to be identified received by the light detector 121.

FIG. 7 is a conceptual diagram for describing focal lengths of an incident optical system and a receiver optical system of the FTIR. With the FTIR, an image 101a of the light source and an image 121a of the light detector are formed on the plastic 123 to be identified. In FIG. 7, the positions of the images 101a and 121a are different for the sake of convenience, but normally, with the FTIR, the images 101a and 121a are formed at the same position.

Normally, the sizes of the images 101a and 121a are the same. Also, mirrors with the same focal length f₀ are used as the incident mirror (or lens) 115 for causing light to enter the plastic 123 to be identified and the receiver mirror (or lens) 117 for receiving reflected light, to prevent a mismatch in the numerical aperture (NA). As an example of a general configuration, the focal length of each mirror is 60 mm for the collimator mirror (or lens) 107, 100 mm for the incident mirror 115, 100 mm for the receiver mirror 117, and 50 mm for the converging mirror (or lens) 119.

As described above, the plastic identification device uses the difference in the shape of the reflectance spectrum from a plastic to be identified at the time of identifying the type of a plastic to be identified. To determine this difference, sufficient intensity of reflected light has to be obtained. The accuracy of identification is reduced as the intensity of reflected light is reduced.

Now, the shapes of plastics to be identified are various. For example, if the shape, at a portion where light is to enter, of a plastic to be identified is not flat and is an irregular shape, light is reflected at an azimuth greatly different from the specular reflection based on a sample installation table on which the plastic to be identified is placed, and a sufficient amount of reflected light may not be obtained.

Conventionally, preprocessing for flattening the portion of a plastic to be identified where light is to enter by cutting or hot-pressing is sometimes performed so as to obtain a sufficient amount of reflected light (see Japanese Patent Laid-open Publication No. 2001-221727 mentioned above).

However, there is an issue that the configuration of the plastic identification device is complicated by the addition of the preprocessing step. Furthermore, with respect to the hot-pressing, there is an issue of thermal deformation of a target plastic. Also, because a large number of plastics are pressed by the same press machine, there is an issue that dirt or plastic itself of a plastic pressed earlier may stick to another plastic at the time of pressing of this plastic.

### SUMMARY OF THE INVENTION

A plastic identification device of the present invention aims to increase the accuracy of identification of the type of a plastic even for a plastic to be identified whose shape at a portion where light is to enter is irregular.

The plastic identification device of the present invention includes a sample holding unit for holding, as a sample, a plastic to be identified, an infrared spectrophotometer including a light source for generating infrared light, an incident optical system for emitting the infrared light from the light source on the sample held by the sample holding unit, a light detector, and a receiver optical system for guiding the infrared light from the sample to the light detector, and a calculation device for identifying a type of the plastic which is the sample based on a detection result of the light detector. Also, a focal length of the incident optical system is shorter than a focal length of the receiver optical system.

Because the focal length of the incident optical system is made shorter than the focal length of the receiver optical system, the energy density of incident light on a sample is increased. The intensity of light received by the receiver optical system from the sample is thereby also increased, and the accuracy of identification of the type of a plastic is increased even with a sample whose shape at a portion where light is to enter is irregular.

Further, this makes preprocessing for flattening a portion of a sample where light is to enter unnecessary. Thus, according to one aspect, the sample holding unit does not include a structure for performing preprocessing for correcting a shape of the sample, and may hold the sample which has been supplied, while maintaining the shape. Accordingly, the configuration of the plastic identification device may be prevented from becoming complicated.

According to another aspect, the incident optical system and the receiver optical system are configured in such a way that a size of an image of the light detector formed on the sample is same as, or greater than, a size of an image of the light source formed on the sample. Accordingly, light from the sample can be efficiently guided to the light detector. On the other hand, the present invention also includes an incident optical system and a receiver optical system that are configured in such a way that a size of an image of a light detector is smaller than a size of an image of a light source.

An example of the infrared spectrophotometer is a Fourier transform infrared spectrophotometer.

### BRIEF DESCRIPTION OF THE DRAWINGS

FIG. 1 is a schematic configuration diagram for describing an embodiment of a plastic identification device;

FIG. 2 is a conceptual diagram for describing focal lengths of an incident optical system and a receiver optical system of the embodiment;

FIG. 3 is a diagram showing results of studying the sample height dependency of the intensity of reflected light with respect to a sample whose shape at a portion where light is to enter is flat;

FIG. 4 is a diagram showing results of studying the sample height dependency of the intensity of reflected light with respect to a sample whose shape at a portion where light is to enter is irregular;

FIG. 5 is a schematic configuration diagram of a FTIR;

FIG. 6 is a diagram for describing a relationship between displacement of a movable mirror and interferogram intensity in the FTIR; and

FIG. 7 is a conceptual diagram for describing focal lengths of an incident optical system and a receiver optical system of the FTIR.

### DETAILED DESCRIPTION OF THE PREFERRED EMBODIMENT

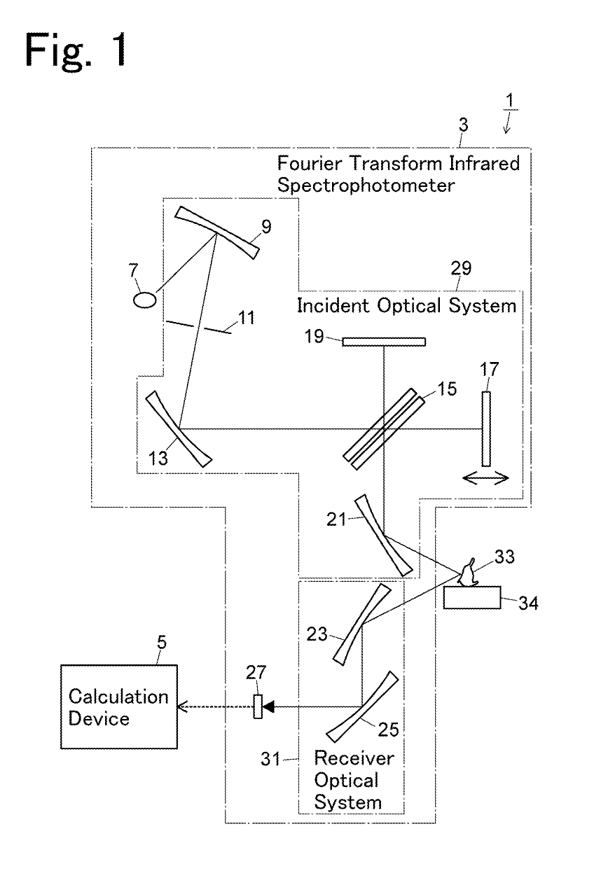

FIG. 1 is a schematic configuration diagram for describing an embodiment of a plastic identification device.

A plastic identification device 1 includes a Fourier transform infrared spectrophotometer 3, and a calculation device 5 for identifying the type of a plastic 33 to be identified, based on a detection result of the Fourier transform infrared spectrophotometer 3.

The Fourier transform infrared spectrophotometer 3 includes an infrared light source 7, an incident optical system 29, a sample holding unit 34, a receiver optical system 31, a light detector 27, and the calculation device 5.

The incident optical system 29 includes a converging mirror 9, an aperture 11, a collimator mirror 13, a beam splitter 15, a movable mirror 17, a fixed mirror 19, and an incident mirror 21. The light source 7 emits light including a mid-infrared region. Light emitted from the light source 7 enters the beam splitter 15 via the converging mirror 9, the aperture 11, and the collimator mirror 13, and is split by the beam splitter 15 into two directions to the movable mirror 17 and the fixed mirror 19. Light reflected by the movable mirror 17 and light reflected by the fixed mirror 19 are combined by the beam splitter 15. The movable mirror 17 is displaced in the direction of the arrow in FIG. 1 by a drive system not shown. The light combined by the beam splitter 15 thereby becomes combined light. The combined light in the mid-infrared region from the beam splitter 15 is reflected by the incident mirror 21, and is collected on and enters the plastic 33 to be identified as a sample placed at a predetermined measurement position on the sample holding unit 34.

The sample holding unit 34 is to hold as a sample, while maintaining the shape, the plastic 33 to be identified which has been supplied, and does not include a structure for performing preprocessing for flattening a light incident portion of the sample. The sample holding unit 34 is a belt conveyor, for example, and holds, as it is, the plastic 33 to be identified which has been crushed into a thin (flake) shape and which is supplied.

The receiver optical system 31 includes a receiver mirror 23, and a converging mirror 25. Light from the plastic 33 to be identified enters the receiver mirror 23. The light from the plastic 33 to be identified here is either reflected light or scattered light, or both. Light reflected by the receiver mirror 23 enters the light detector 27 via the converging mirror 25.

The calculation device 5 identifies the type of the plastic 33 to be identified, based on the shape of the reflectance spectrum of the plastic 33 to be identified received by the light detector 27.

FIG. 2 is a conceptual diagram for describing the focal lengths of the incident optical system 29 and the receiver optical system 31 of the Fourier transform infrared spectrophotometer 3. Due to the purpose of FIG. 2 which is to describe a concept, concave mirrors 13, 21, 23, and 25 are expressed as convex lenses, but the concave mirrors 13, 21, 23, and 25 may be actually replaced by convex lenses.

An image 7a of the light source is formed on the plastic 33 to be identified, by the incident optical system 29. Also, an image 27a of the light detector is formed on the plastic 33 to be identified, by the receiver optical system 31. In FIG. 2, the positions of the images 7a and 27a are different for the sake of convenience, but the images 7a and 27a are formed at the same position. Additionally, the positions of the images 7a and 27a do not have to be the same.

A focal length f₁ of the incident mirror 21 of the incident optical system 29 is shorter than a focal length f₀ of the receiver mirror 23 of the receiver optical system 31. Since the focal length of the incident mirror 21 is reduced, the image 7a of the light source on the plastic 33 to be identified is reduced, and the energy density of incident light on the plastic 33 to be identified is increased. On the other hand, with respect to high NA light in the incident light, a loss occurs at the time of reception by the receiver mirror 23 due to an NA mismatch.

Further, the size of the image 27a of the light detector on the plastic 33 to be identified is made the same or greater than the size of the image 7a of the light source. Thus, the receiver optical system 31 can receive light from the plastic 33 to be identified from a wider region. Additionally, the size of the image 27a of the light detector may be smaller than the size of the image 7a of the light source.

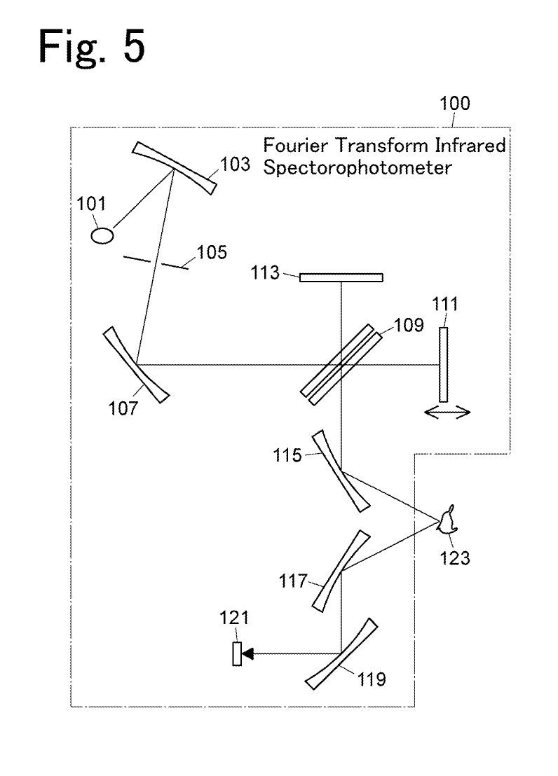

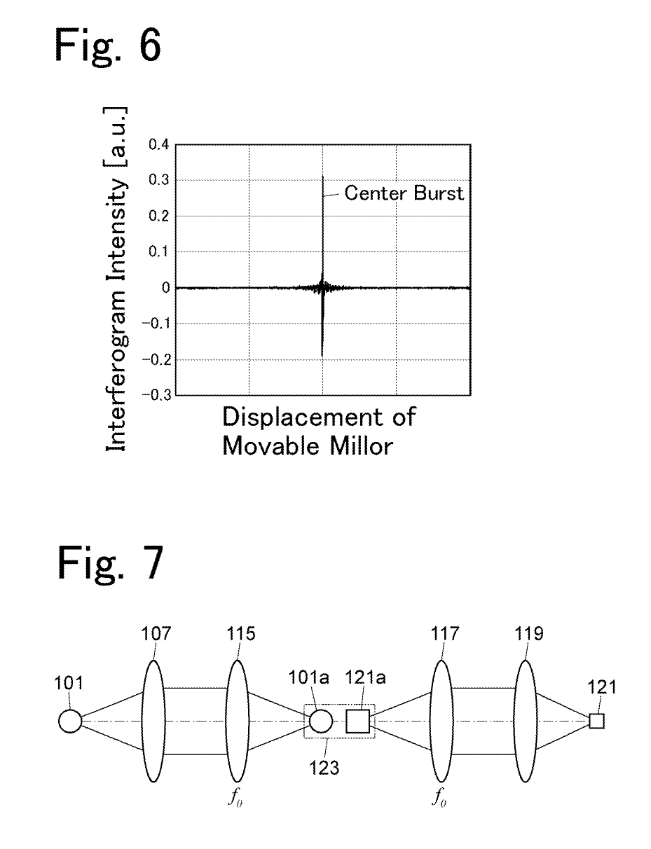

The intensities of the reflected light from the plastic to be identified are compared for the plastic identification device of the present embodiment (see FIG. 1) and a conventional plastic identification device (see FIG. 5) according to which the focal lengths of a transmitter optical system and a receiver optical system are the same.

As the optical system of the conventional plastic identification device, [f102-f102] according to which the focal length of the incident mirror 115 is 102 mm, and the focal length of the receiver mirror 117 is 102 mm is used (see FIG. 7).

As the optical systems of the plastic identification device 1 of the embodiment, [f51-f102] according to which the focal length of the incident mirror 21 is 51 mm, and the focal length of the receiver mirror 23 is 102 mm, and [f76-f102] according to which the focal length of the incident mirror 21 is 76 mm, and the focal length of the receiver mirror 23 is 102 mm are used (see FIG. 2). As the incident mirrors 21 and 115, and the receiver mirrors 23 and 117, 90-degree off-axial paraboloidal mirrors are used. Comparison is performed based on these three types of optical systems.

As the plastic to be identified, one formed of acrylonitrile butadiene styrene (ABS) resin is used. Also, measurement is conducted on two types of plastics to be identified: <Sample 1> a sample which is flat-shaped at a portion where light is to enter, and <Sample 2> a sample which is irregularly shaped at a portion where light is to enter. Comparison is conducted regarding the intensities of reflected light while changing the heights of the samples. The intensity of reflected light is evaluated based on the intensity of center burst of the interferogram. The intensity of center burst is the light intensity at the time when the optical path difference between the two is zero in the Michelson interferometer and there is constructive interference among all the wavelengths, and is used as an index of signal intensity in reflectance spectrum analysis.

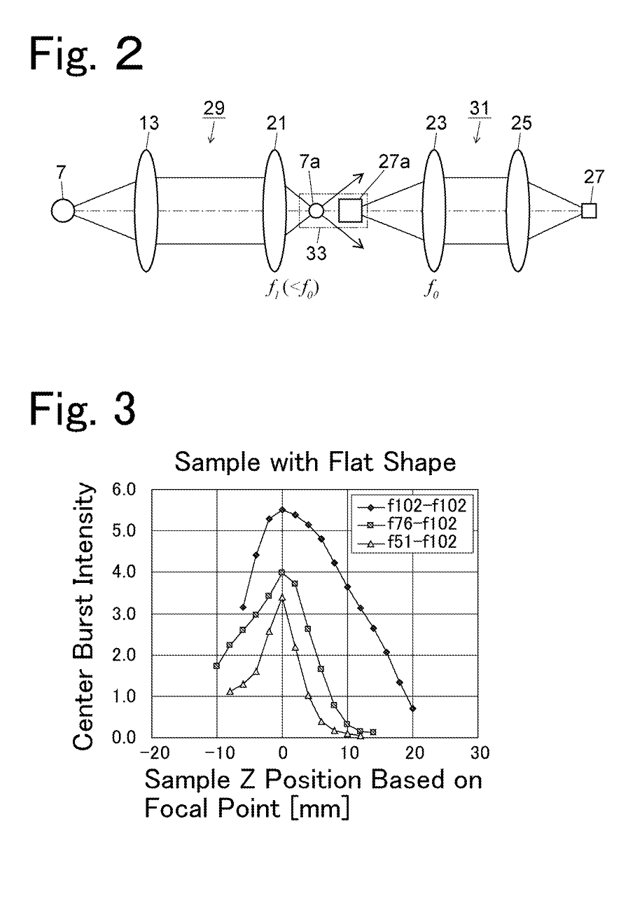

FIG. 3 is a diagram showing results of studying the sample height dependency of the intensity of reflected light with respect to sample 1 whose shape at a portion where light is to enter is flat. In FIG. 3, the vertical axis represents the intensity of center burst (arbitrary unit), and the horizontal axis represents the sample height position (mm) based on the focal point.

With respect to sample 1, the intensity of reflected light is the greatest for the conventional optical system [f102-f102], and the intensity of reflected light is reduced as the focal length of the incident mirror is reduced for the optical systems [f51-f102] and [f76-f102] of the embodiment. The possible reason is that high NA light is not received by the short-focus optical systems [f51-f102] and [f76-f102] due to the NA mismatch.

With respect to sample 1, the signal intensity is lower for the optical systems [f51-f102] and [f76-f102] of the embodiment than for the conventional optical system [f102-f102], but the intensities of center burst are 3 or higher. The plastic identification device is capable of identifying the type of a plastic if the intensity of center burst is at or above a predetermined intensity, for example, at or above 0.5. Accordingly, in the case of a plastic to be identified such as sample 1 whose shape at a portion where light is to enter is flat, a sufficient intensity of reflected light is obtained, and no problem arises for any of the three types of optical systems.

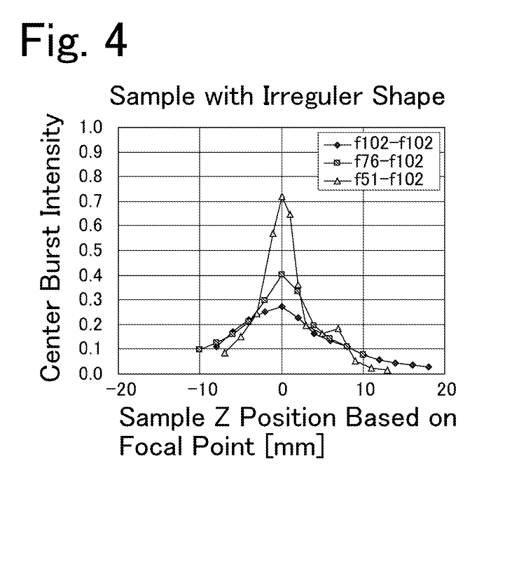

FIG. 4 is a diagram showing results of studying the sample height dependency of the intensity of reflected light with respect to sample 2 whose shape at a portion where light is to enter is irregular. In FIG. 4, the vertical axis represents the intensity of center burst (arbitrary unit), and the horizontal axis represents the sample height position (mm) based on the focal point.

With respect to sample 2, the intensity of center burst is the greatest for the short-focus optical system [f51-f102] with the maximum intensity of center burst being at or above 0.7. As described above, identification of the type of a plastic is possible if the intensity of center burst is at or above 0.5, for example. Accordingly, the plastic identification device of the embodiment using the optical system [f51-f102] is capable of identifying the type of a plastic even when the plastic is sample 2 whose shape at a portion where light is to enter is irregular.

Furthermore, in the case of the conventional optical system [f102-f102], the intensity of center burst is less than 0.3, and identification of the type of a plastic is difficult. In the case of the short-focus optical system [f76-f102] the intensity of center burst is at or above 0.4, and the accuracy of identification of the type of a plastic is increased compared to the case of the conventional optical system [f102-f102].

As described above, the optical system with increased energy density of incident light achieved by reducing the focal length of the incident mirror is advantageous with respect to a plastic to be identified whose shape at a portion where light is to enter is irregular, such as sample 2.

With the focal length of the incident mirror 21 made shorter than that of the receiver mirror 23 in the plastic identification device 1, the energy density of incident light on the plastic 33 to be identified is increased, and the signal intensity of the light detector 27 at the time of measurement of the plastic 33 to be identified whose shape at a portion where light is to enter is irregular is increased. The accuracy of identification regarding the plastic 33 to be identified having an irregular shape, whose identification by the conventional optical system is not possible or inaccurate due to low signal intensity, is thereby increased for the plastic identification device 1, and the plastic identification device 1 is enabled to identify the type of the plastic.

Heretofore, an embodiment of the present invention has been described, but the configuration, arrangement, numerical values and the like of the embodiment are only examples and the present invention is not restricted by the above, and various modifications are possible within the scope of the present invention described in the scope of claims

For example, in the embodiment described above, as the Fourier transform infrared spectrophotometer, one provided with the Michelson interferometer is used, but in the plastic identification device of the present invention, the interferometer configuring the Fourier transform infrared spectrophotometer may be an interferometer other than the Michelson interferometer. The Fourier transform infrared spectrophotometer is not restricted to the spectrophotometer 3 in the embodiment described above, and it may have any configuration as long as it is a Fourier transform infrared spectrophotometer according to which light from a light source is emitted on a plastic to be identified via an incident optical system, and light from the plastic to be identified is detected by a light detector via a receiver optical system. Furthermore, application to an infrared spectrophotometer other than the Fourier transform infrared spectrophotometer is also possible.

In the embodiment described above, light in the mid-infrared region is used, but the plastic identification device of the present invention may also use infrared rays of other wavelengths or light of other types of wavelengths.

Also, in the embodiment described above, mirrors 21 and 23 are used as optical elements for determining the focal length of the incident optical system 29 and the focal length of the receiver optical system 31, but the optical elements for determining these focal lengths in the plastic identification device of the present invention are not restricted to mirrors, and other optical elements, such as optical lenses, may also be used.

What is claimed is:

1. A plastic identification device comprising:
a sample holding unit for holding, as a sample, a plastic to be identified;
an infrared spectrophotometer including a light source for generating infrared light, an incident optical system for emitting the infrared light from the light source on the sample held by the sample holding unit, a light detector, and a receiver optical system for guiding the infrared light from the sample to the light detector; and
a calculation device for identifying a type of the plastic which is the sample based on a detection result of the light detector,
wherein a focal length of the incident optical system is shorter than a focal length of the receiver optical system.

2. The plastic identification device according to claim 1, wherein the sample holding unit does not include a structure for performing preprocessing for correcting a shape of the sample, and holds the sample which has been supplied, while maintaining the shape.

3. The plastic identification device according to claim 2, wherein the incident optical system and the receiver optical system are configured so that a size of an image of the light detector formed on the sample is same as, or greater than, a size of an image of the light source formed on the sample

4. The plastic identification device according to claim 1, wherein the incident optical system and the receiver optical system are configured so that a size of an image of the light detector formed on the sample is same as, or greater than, a size of an image of the light source formed on the sample

5. The plastic identification device according to claim 1, wherein the infrared spectrophotometer is a Fourier transform infrared spectrophotometer.
